(19) United States
(12) Patent Application Publication
(10) Pub. No.: US 2026/0303333 A1
(43) Pub. Date: Oct. 1, 2026

(54) COMMUNICATION SYSTEM, INFORMATION PROCESSING DEVICE, COMMUNICATION METHOD, AND COMPUTER-READABLE MEDIUM

(71) Applicant: NEC Corporation, Tokyo (JP)

(72) Inventors: Takao OCHI, Tokyo (JP); Toshihiko OKAMURA, Tokyo (JP)

(73) Assignee: NEC Corporation, Tokyo (JP)

(21) Appl. No.: 19/475,862

(22) PCT Filed: May 15, 2023
(86) PCT No.: PCT/JP2023/018124

§ 371 Date: Oct. 16, 2025

(51) Int. Cl. H04L 9/08

(52) U.S. Cl. CPC H04L 9/0852; H04L 9/083

(57) ABSTRACT

The first information processing device includes: a first acquisition unit that acquires key data from the key supplying base; a generation unit that encrypts first data by means of the key data and generates second data by adding attribute information related to encryption to the encrypted first data; and a transmission unit that uploads the second data to an external device. The second information processing device includes: a second acquisition unit that acquires the key data from the key supplying base; a reception unit that downloads the second data from the external device; and a decryption unit that identifies the key data on the basis of the attribute information included in the second data and decrypts the first data included in the second data by means of the key data.

### TECHNICAL FIELD

The present disclosure relates to a communication system, an information processing device, a communication method, and a non-transitory computer-readable medium storing a program.

### BACKGROUND ART

PTL 1 discloses a technique in which a QKD system on a terminal side and a QKD system on a cloud server side generate a quantum key by a quantum network.

### CITATION LIST

### Patent Literature

PTL 1: JP 2018-500843 A

### SUMMARY OF INVENTION

### Technical Problem

However, in the technique disclosed in PTL 1, for example, a problem to be raised in a case of sharing data among a plurality of users via storage, such as the cloud, has not been considered.

In view of the problem described above, an object of the present disclosure is to provide a technique by which security in a case of sharing data among a plurality of users may be improved.

### Solution to Problem

According to a first aspect of the present disclosure, there is provided a communication system including a first information processing device, a second information processing device, and a key supply base, in which the first information processing device includes a first acquisition unit that obtains key data from the key supply base, a generation unit that encrypts first data using the key data and generates second data in which attribute information regarding encryption is added to the encrypted first data, and a transmission unit that uploads the second data to an external device, and the second information processing device includes a second acquisition unit that obtains the key data from the key supply base, a reception unit that downloads the second data from the external device, and a decryption unit that identifies the key data based on the attribute information included in the second data and decrypts the first data included in the second data using the key data.

According to a second aspect of the present disclosure, there is provided an information processing device including an acquisition unit that obtains key data from a key supply base, a generation unit that encrypts first data using the key data and generates second data in which attribute information regarding encryption is added to the encrypted first data, and a transmission unit that uploads the second data to an external device.

According to a third aspect of the present disclosure, there is provided an information processing device including an acquisition unit that obtains key data from a key supply base, a reception unit that downloads second data from an external device, and a decryption unit that identifies the key data based on the attribute information included in the second data and decrypts the first data included in the second data using the key data.

According to a fourth aspect of the present disclosure, there is provided a communication method causing a first information processing device to perform a process including obtaining key data from a key supply base, encrypting first data using the key data and generating second data in which attribute information regarding encryption is added to the encrypted first data, and uploading the second data to an external device, the method causing a second information processing device to perform a process including obtaining the key data from the key supply base, downloading the second data from the external device, and identifying the key data based on the attribute information included in the second data and decrypting the first data included in the second data using the key data.

According to a fifth aspect of the present disclosure, there is provided a communication method including obtaining key data from a key supply base, encrypting first data using the key data and generating second data in which attribute information regarding encryption is added to the encrypted first data, and uploading the second data to an external device.

According to a sixth aspect of the present disclosure, there is provided a communication method including obtaining the key data from a key supply base, downloading the second data from an external device, and identifying the key data based on the attribute information included in the second data and decrypting the first data included in the second data using the key data.

According to a seventh aspect of the present disclosure, there is provided a non-transitory computer-readable medium storing a program for causing a computer to perform a process including obtaining key data from a key supply base, encrypting first data using the key data and generating second data in which attribute information regarding encryption is added to the encrypted first data, and uploading the second data to an external device.

According to an eighth aspect of the present disclosure, there is provided a non-transitory computer-readable medium storing a program for causing a computer to perform a process including obtaining the key data from a key supply base, downloading the second data from an external device, and identifying the key data based on the attribute information included in the second data and decrypting the first data included in the second data using the key data.

### Advantageous Effects of Invention

According to one aspect, security may be improved in a case of sharing data among a plurality of users.

### BRIEF DESCRIPTION OF DRAWINGS

FIG. 1 is a diagram illustrating an exemplary configuration of a communication system according to an example embodiment.

FIG. 2 is a diagram illustrating an exemplary configuration of an information processing device according to the example embodiment.

FIG. 3 is a diagram illustrating an exemplary hardware configuration of the information processing device according to the example embodiment.

FIG. 4 is a sequence diagram illustrating an exemplary process of the communication system according to the example embodiment.

FIG. 5 is a diagram illustrating an exemplary key management DB according to the example embodiment. FIG. 6 is a diagram illustrating exemplary second data according to the example embodiment.

FIG. 7 is a diagram illustrating exemplary key DB according to the example embodiment.

### EXAMPLE EMBODIMENT

The principles of the present disclosure will be described with reference to some example embodiments. It is to be understood that the example embodiments are described for the purpose of illustration only, and will aid those skilled in the art in understanding and carrying out the present disclosure without suggesting limitations on the scope of the present disclosure. The disclosure described in the present specification is implemented in various methods other than those to be described below.

In the following description and claims, unless defined otherwise, all technical and scientific terms used in the present specification have the same meaning as commonly understood by those skilled in the art of the technical field to which the present disclosure belongs.

Hereinafter, an example embodiment of the present disclosure will be described with reference to the drawings.

### First Example Embodiment

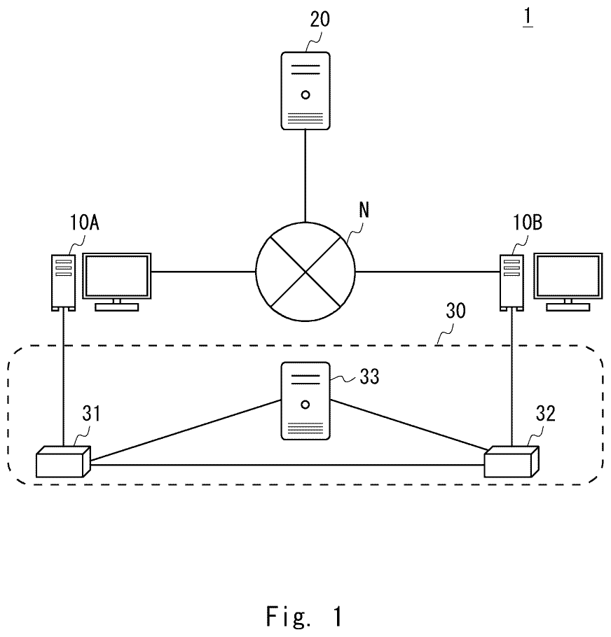

A configuration of a communication system 1 according to an example embodiment will be described with reference to FIG. 1.

### System Configuration

FIG. 1 is a diagram illustrating an exemplary configuration of the communication system 1 according to the example embodiment. In the example of FIG. 1, the communication system 1 includes an information processing device 10A (an example of a “first information processing device”) and an information processing device 10B (an example of a “second information processing device”) (hereinafter, also simply referred to as an “information processing device 10” if no distinction is required). The communication system 1 further includes a storage server 20 (an example of an “external device”) and a key supply base 30. The numbers of the information processing devices 10, the storage servers 20, and the key supply bases 30 are not limited to the example of FIG. 1.

In the example of FIG. 1, the information processing device 10A, the information processing device 10B, and the storage server 20 are communicably connected by a network N. Examples of the network N include the Internet, a mobile communication system, a wireless local area network (LAN), short-range wireless communication such as Bluetooth Low Energy (BLE), a LAN, a bus, and the like. Examples of the mobile communication system include a fifth-generation mobile communication system (5G), a fourth-generation mobile communication system (4G), a third-generation mobile communication system (3G), and the like.

In the example of FIG. 1, the key supply base 30 includes a transmitter 31, a receiver 32, and a key management server 33. The information processing device 10A and the transmitter 31 may be connected by, for example, a LAN, a bus, or the like. The information processing device 10B and the receiver 32 may be connected by, for example, a LAN, a bus, or the like.

The transmitter 31 transmits (distributes) key data to the receiver 32. The key management server 33 manages key data to be supplied from the key supply base 30 to the information processing device 10. For example, the key management server 33 may generate key data as appropriate, record the generated key data, and supply (provide) it to the transmitter 31.

The key supply base 30 may be, for example, a system that performs quantum key distribution (QKD) for detecting eavesdropping using the principle of quantum mechanics at a time of distributing key data. In that case, for example, the transmitter 31 may transmit the key data to the receiver 32 using, for example, a BB84 scheme of transmitting 1-bit key information for each photon, a CV-QKD scheme of transmitting 1-bit key information on a phase difference between a weak light wave and normal light, or the like.

The information processing device 10 may be, for example, a device such as a personal computer, a smartphone, or the like. The information processing device 10A causes the information processing device 10B to obtain data through the storage server 20. More specifically, the information processing device 10A encrypts specific data using the key data obtained from the transmitter 31. Then, the information processing device 10A uploads the encrypted specific data to the storage server 20. Then, the information processing device 10B downloads the encrypted specific data from the storage server 20. Then, the information processing device 10B decrypts the encrypted specific data using the key data obtained from the receiver 32.

### Configuration

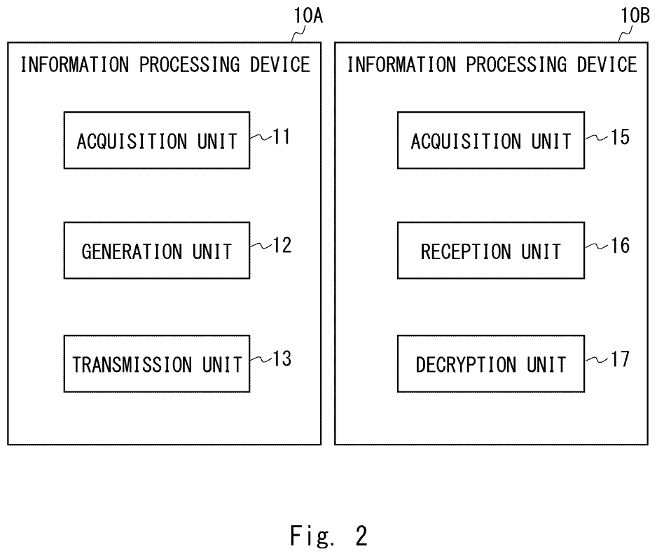

Next, a configuration of the information processing device 10 according to the example embodiment will be described with reference to FIG. 2. FIG. 2 is a diagram illustrating an exemplary configuration of the information processing device 10 according to the example embodiment.

### Configuration of Information Processing Device 10A

The information processing device 10A includes an acquisition unit 11, a generation unit 12, and a transmission unit 13. Those units may be implemented by cooperation of one or more programs installed in the information processing device 10A and hardware of the information processing device 10A, such as a processor 101, a memory 102, and the like.

The acquisition unit 11 obtains key data from the key supply base 30.

The generation unit 12 encrypts first data (e.g., data file to be shared) using the key data obtained by the acquisition unit 11, and generates second data in which attribute information regarding encryption is added to the encrypted first data.

The transmission unit 13 uploads the second data generated by the generation unit 12 to the storage server 20.

### Configuration of Information Processing Device 10B

The information processing device 10A includes an acquisition unit 15, a reception unit 16, and a decryption unit 17. Those units may be implemented by cooperation of one or more programs installed in the information processing device 10B and hardware of the information processing device 10B, such as the processor 101, the memory 102, and the like.

The acquisition unit 15 obtains key data from the key supply base 30.

The reception unit 16 downloads the second data from the storage server 20.

The decryption unit 17 identifies the key data based on the attribute information included in the second data received by the reception unit 16, and decrypts the first data included in the second data using the key data.

### Hardware Configuration

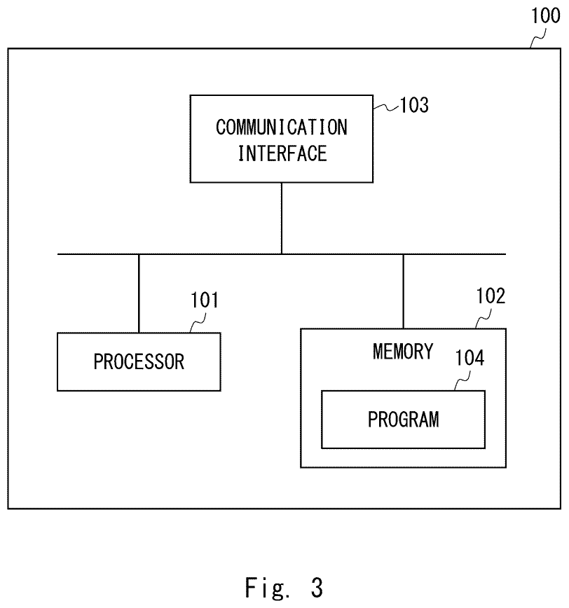

FIG. 3 is a diagram illustrating an exemplary hardware configuration of the information processing device 10 according to the example embodiment. In the example of FIG. 3, the information processing device 10 (computer 100) includes the processor 101, the memory 102, and a communication interface 103. Those units may be connected by a bus or the like. The memory 102 stores at least a part of a program 104. The communication interface 103 includes an interface necessary for communication with other network elements.

Once the program 104 is executed by the processor 101, the memory 102, and the like in cooperation with each other, at least a part of the processing according to the example embodiment of the present disclosure is performed by the computer 100. The memory 102 may be of any type. The memory 102 may be a non-transitory computer-readable storage medium, as a non-limiting example. The memory 102 may also be implemented using any suitable data storage technique, such as a semiconductor-based memory device, a magnetic memory device and system, an optical memory device and system, a fixed memory, or a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a digital signal processor (DSP), and a processor based on a multi-core processor architecture as a non-limiting example. The computer 100 may include a plurality of processors, such as an application specific integrated circuit chip that is temporally dependent on a clock that synchronizes the main processor.

Example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor, or another computing device.

The present disclosure also provides at least one computer program product tangibly stored in a non-transitory computer-readable storage medium. The computer program product includes computer-executable commands, such as those included in a program module, and is executed by a device on a target real or virtual processor to perform a process or method of the present disclosure. The program module includes routines, programs, libraries, objects, classes, components, data structures, and the like that execute specific tasks or implement specific abstract data types. Functions of the program module may be combined or divided between the program modules as desired in various example embodiments. A machine-executable command of the program module may be executed in a local or distributed device. In the distributed device, the program modules may be located on both local and remote storage media.

Program codes for executing the method of the present disclosure may be written in any combination of one or more programming languages. Those program codes are provided to a processor or controller of a general purpose computer, a dedicated computer, or another programmable data processing device. Once the program codes are executed by the processor or controller, functions/operations in a flowchart and/or implemented block diagram are performed. The program codes are executed entirely on the machine, partially on the machine, as a stand-alone software package, partially on the machine, partially on a remote machine, or entirely on the remote machine or server.

The program includes commands (or software codes) for causing the computer to perform one or more functions described in the example embodiment in a case of being read by the computer. The program may be stored in a non-transitory computer-readable medium or in a tangible storage medium. As an example and not by way of limitation, the computer-readable medium or tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disk or any other optical disk storage, and a magnetic cassette, a magnetic tape, a magnetic disk storage or any other magnetic storage device. The program may be transmitted on a transitory computer-readable medium or communication medium. As an example and not by way of limitation, the transitory computer-readable medium or communication medium includes electrical, optical, acoustic, or other forms of propagated signals.

### Processing

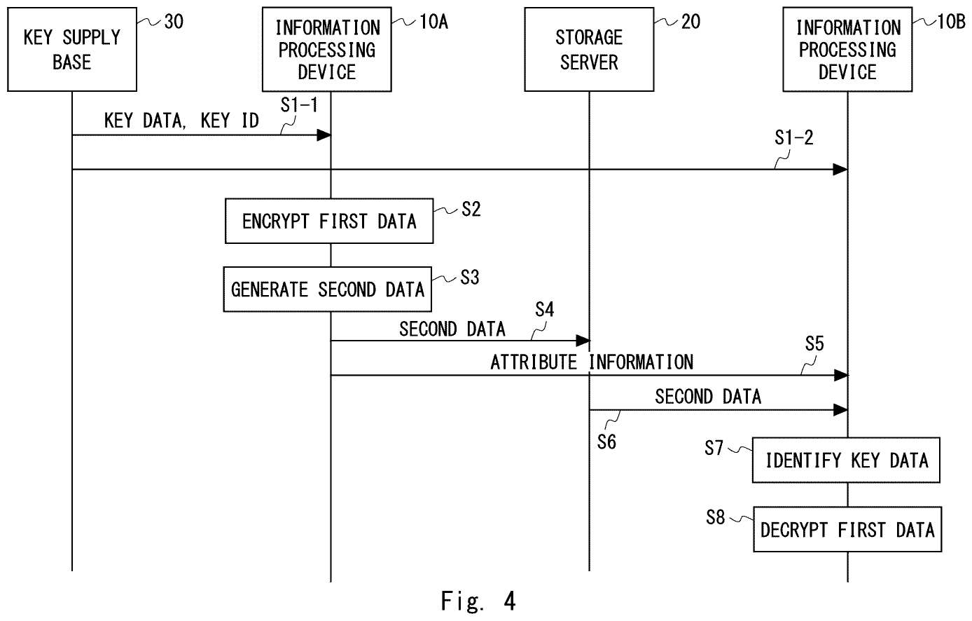

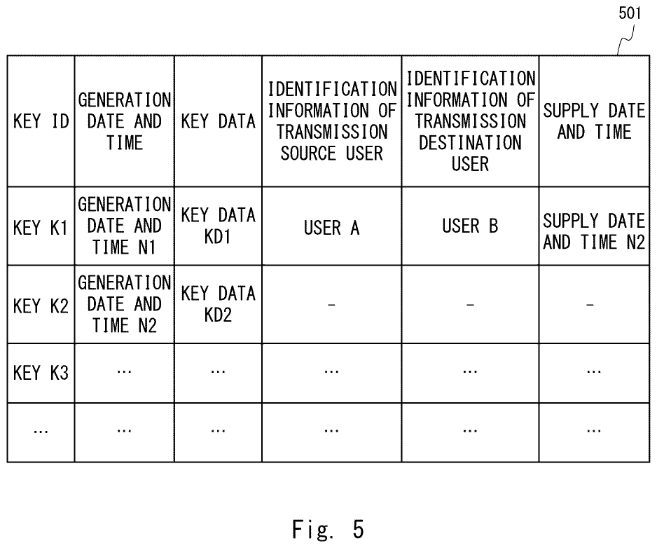

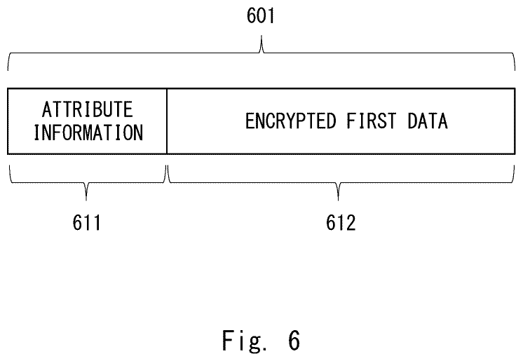

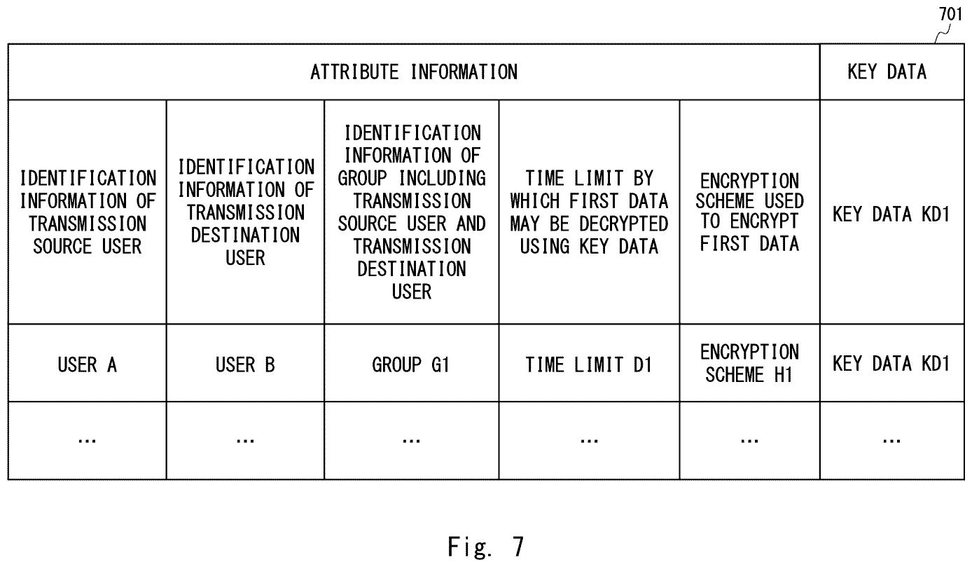

Next, an exemplary process of the communication system 1 according to the example embodiment will be described with reference to FIGS. 4 to 7. FIG. 4 is a sequence diagram illustrating an exemplary process of the communication system 1 according to the example embodiment. FIG. 5 is a diagram illustrating an example of a key management database (DB) 501 according to the example embodiment. FIG. 6 is a diagram illustrating an example of the second data according to the example embodiment. FIG. 7 is a diagram illustrating an example of key DB 701 according to the example embodiment.

The following processing procedure is an example, and the communication system 1 according to the present disclosure may execute the procedure in an appropriately changed order as long as there is no inconsistency. Hereinafter, a user (personal user, organization) of the information processing device 10A will also be referred to as a user A, a user of the information processing device 10B will also be referred to as a user B, and a user of the information processing device 10B will also be referred to as a user C. While a case where the user A transmits key data to the user B and then shares the data from the user A to the user B will be described in the example of FIG. 4, the technique of the present disclosure is not limited thereto. For example, after the user A transmits the key data to the user B, the data may be shared from the user B to the user A (the user B uploads the data to the storage server 20, and the user A downloads the data from the storage server 20) using the received key data.

In step S1-1 to 2, each of the information processing device 10A and the information processing device 10B obtains one or more combinations of key data and key IDs from the key supply base 30. Here, the acquisition unit 11 of the information processing device 10A obtains the key data and the key ID from the transmitter 31 (step S1-1). The acquisition unit 15 of the information processing device 10B obtains, from the receiver 32, the key data and the key ID distributed from the transmitter 31 to the receiver 32, and records them in the key DB 701 to be described later (step S1-2).

The key data and the key ID may be, for example, key data and key ID supplied from the key management server 33 to the transmitter 31 at specific timing. In that case, first, the information processing device 10A may receive an operation for sharing data between the user A and the user B from the user A. The operation may include an operation of designating identification information or the like of the user B.

Then, the information processing device 10A may transmit, to the transmitter 31, a key acquisition request including the identification information of the user A, the identification information of the user B, and the like. Then, the transmitter 31 may transmit, to the key management server 33, a key supply request including the identification information of the user A and the identification information of the user B.

Then, the key management server 33 may record, in the key management DB 501, the identification information of the user A, the identification information of the user B, and information indicating the supply date and time in association with the key ID. The key management DB 501 may be recorded in, for example, a storage device inside the key management server 33. In the example of FIG. 5, a generation date and time, key data, identification information of a transmission source user, identification information of a transmission destination user, and a supply date and time are recorded in association with a key ID. The key ID is identification information of key data. The key management server 33 may generate (determine) a value of the key ID based on, for example, the generation date and time and a hash value of the key data. The generation date and time is a date and time at which the key data is generated by the key management server 33. The key data is data (e.g., random number) of a common key used to encrypt and decrypt a data file.

The identification information of the transmission source user is identification information of a user who transmits the key data using the transmitter 31. The identification information of the transmission destination user is identification information of a user who receives the key data using the receiver 32. The supply date and time is a date and time at which the key data is supplied from the key management server 33 to the transmitter 31. In the example of FIG. 5, it is indicated that a key K1 is supplied for transmission from the user A to the user B. A key K2 is generated and managed by the key management server 33, and is not supplied to the user.

The processing of steps S1-1 and S1-2 may be executed substantially simultaneously, or may be executed at different timings. It is sufficient if the processing of step S1-2 is executed before step S6 to be described later, for example.

Subsequently, the generation unit 12 of the information processing device 10A encrypts the first data using the key data (step S2). Here, the generation unit 12 may encrypt data such as a data file designated by the user A in response to an operation made by the user A, for example.

Subsequently, the generation unit 12 of the information processing device 10A generates second data in which attribute information regarding encryption is added to the encrypted first data (step S3). Here, the attribute information to be added by the generation unit 12 may include identification information (e.g., key ID described above) of the key data.

The attribute information may further include the identification information of the user A, which is the identification information of the transmission source user. The identification information of the user A may be, for example, a mail address of the user A, a uniform resource identifier (URI) of the user A, an account ID of the user A in the storage server 20 or the like, identification information (e.g., IP address, etc.) of the information processing device 10A, or identification information of the transmitter 31. For example, the identification information of the user A may be set in the information processing device 10A in advance, or may be designated by the user A.

The attribute information may further include the identification information of the user B, which is the identification information of the transmission destination user. The identification information of the user B may be, for example, a mail address of the user B, a URI of the user B, an account ID of the user B in the storage server 20 or the like, identification information (e.g., IP address, etc.) of the information processing device 10B, or identification information of the receiver 32. For example, the identification information of the user B may be designated by the user A.

The attribute information may further include identification information of a group including the user A and the user B. The identification information of the group may be, for example, identification information of a shared folder for the group including the user A and the user B set in the storage server 20 or the like in advance. For example, the identification information of the group may be designated by the user A.

The attribute information may further include information indicating a time limit by which the first data may be decrypted using the key data. For example, the time limit may be specified by the user A.

The attribute information may further include information indicating an encryption scheme used to encrypt the first data by the generation unit 12. For example, the encryption scheme may be specified by the user A. The encryption scheme may include, for example, an advanced encryption standard (AES) or the like.

In the example of FIG. 6, second data 601 includes attribute information 611 and encrypted first data 612. For example, the attribute information 611 may be added to the head portion (header) of the second data 601, or may be added to the end portion (trailer) of the second data 601.

Subsequently, the transmission unit 13 of the information processing device 10A uploads the second data to the storage server 20 (step S4). Here, for example, the transmission unit 13 may upload the second data to the storage server 20 designated by the user A in response to an operation made by the user A.

Subsequently, the transmission unit 13 of the information processing device 10A transmits (makes notification regarding) the attribute information to the information processing device 10B (step S5). The reception unit 16 of the information processing device 10B records the received attribute information in the key DB 701 to be described later. In that case, the reception unit 16 may record attribute information other than the key ID in the record associated with the key ID included in the received attribute information. In a case of an embodiment in which only the key ID is included in the attribute information, the processing of step S5 may not be executed.

Subsequently, the reception unit 16 of the information processing device 10B downloads the second data from the storage server 20 (step S6). Here, for example, the reception unit 16 may download the second data designated by the user B in response to an operation made by the user B.

Subsequently, the decryption unit 17 of the information processing device 10B identifies the key data for decrypting the second data based on the attribute information included in the second data (step S7). Here, the decryption unit 17 may obtain, from the key DB 701, the key data associated with the attribute information that matches the attribute information included in the second data.

As a result, the key data to be used this time may be more quickly identified even in a case of using key data having a relatively large data size, such as one time pad (OTP) using a random number of the same length as the communication volume, to improve security, for example.

In the example of FIG. 7, key data is recorded in the key DB 701 in association with the attribute information. The attribute information is attribute information notified from the information processing device 10A to the information processing device 10B. The key data is key data distributed from the transmitter 31 to the receiver 32. In the example of FIG. 7, the attribute information includes the identification information of the transmission source user, the identification information of the transmission destination user, the identification information of the group including the transmission source user and the transmission destination user, the time limit by which the first data may be decrypted using the key data, and the information indicating the encryption scheme used to encrypt the first data. The key DB 701 may be recorded in, for example, a storage device inside the information processing device 10B.

Subsequently, the decryption unit 17 of the information processing device 10B decrypts the first data included in the second data using the identified key data (step S8). As a result, the user B is enabled to, for example, browse the file shared by the user A.

If the current date and time exceeds the time limit by which the first data may be decrypted using the key data, the decryption unit 17 may delete the record of the key data from the key DB 701. As a result, for example, the user B may not be allowed to decrypt the data shared by the user A if the time limit specified by the user A is exceeded.

### Modified Example

While the information processing device 10 (each of the information processing device 10A and the information processing device 10B) may be a device contained in one housing, the information processing device 10 according to the present disclosure is not limited thereto. Each unit of the information processing device 10 may be implemented by, for example, cloud computing including one or more computers. At least a part of the processing of at least one of the information processing device 10A and the information processing device 10B may be implemented by, for example, at least one of the storage server 20 and the key supply base 30. The information processing device 10A may incorporate the transmitter 31 in the housing, for example. The information processing device 10B may incorporate the receiver 32 in the housing, for example. Such an information processing device 10 is also included in an example of the “information processing device” according to the present disclosure.

The present disclosure is not limited to the example embodiments described above, and may be appropriately modified without departing from the scope.

Some or all of the example embodiments described above may be described as, but are not limited to, the following Supplementary Notes.

### Supplementary Note 1

A communication system including a first information processing device, a second information processing device, and a key supply base, in which
the first information processing device includes:
a first acquisition unit that obtains key data from the key supply base;
a generation unit that encrypts first data using the key data, and generates second data in which attribute information regarding encryption is added to the encrypted first data; and
a transmission unit that uploads the second data to an external device, and
the second information processing device includes:
a second acquisition unit that obtains the key data from the key supply base;
a reception unit that downloads the second data from the external device; and
a decryption unit that identifies the key data based on the attribute information included in the second data, and decrypts the first data included in the second data using the key data.

### Supplementary Note 2

The communication system according to Supplementary Note 1, in which the key supply base performs quantum key distribution (QKD) for detecting eavesdropping using a principle of quantum mechanics at a time of distributing the key data.

### Supplementary Note 3

The communication system according to Supplementary Note 1, in which the attribute information includes identification information of the key data.

### Supplementary Note 4

The communication system according to Supplementary Note 1, in which the attribute information includes identification information of a user of the first information processing device.

### Supplementary Note 5

The communication system according to Supplementary Note 1, in which the attribute information includes identification information of a user of the second information processing device.

### Supplementary Note 6

The communication system according to Supplementary Note 1, in which the attribute information includes identification information of a group including a user of the first information processing device and a user of the second information processing device.

### Supplementary Note 7

The communication system according to Supplementary Note 1, in which the attribute information includes information indicating a time limit by which the first data may be decrypted using the key data.

### Supplementary Note 8

The communication system according to Supplementary Note 1, in which the attribute information includes information indicating an encryption scheme used to encrypt the first data.

### Supplementary Note 9

An information processing device including:
an acquisition unit that obtains key data from a key supply base;
a generation unit that encrypts first data using the key data, and generates second data in which attribute information regarding encryption is added to the encrypted first data; and
a transmission unit that uploads the second data to an external device.

### Supplementary Note 10

An information processing device including:
an acquisition unit that obtains key data from a key supply base;
a reception unit that downloads second data from an external device; and
a decryption unit that identifies the key data based on attribute information included in the second data, and decrypts first data included in the second data using the key data.

### Supplementary Note 11

A communication method causing a first information processing device to perform a process including:
obtaining key data from a key supply base;
encrypting first data using the key data and generating second data in which attribute information regarding encryption is added to the encrypted first data; and
uploading the second data to an external device,
the method causing a second information processing device to perform a process including:
obtaining the key data from the key supply base;
downloading the second data from the external device; and
identifying the key data based on the attribute information included in the second data and decrypting the first data included in the second data using the key data.

### Supplementary Note 12

A communication method including:
obtaining key data from a key supply base;
encrypting first data using the key data and generating second data in which attribute information regarding encryption is added to the encrypted first data; and uploading the second data to an external device.

### Supplementary Note 13

A communication method including:
obtaining key data from a key supply base;
downloading second data from an external device; and
identifying the key data based on attribute information included in the second data and decrypting first data included in the second data using the key data.

### Supplementary Note 14

A non-transitory computer-readable medium storing a program for causing a computer to perform a process including:
obtaining key data from a key supply base;
encrypting first data using the key data and generating second data in which attribute information regarding encryption is added to the encrypted first data; and
uploading the second data to an external device.

### Supplementary Note 15

A non-transitory computer-readable medium storing a program for causing a computer to perform a process including:
obtaining key data from a key supply base;
downloading second data from an external device; and
identifying the key data based on attribute information included in the second data and decrypting first data included in the second data using the key data.

### REFERENCE SIGNS LIST

1 communication system
10A information processing device
11 acquisition unit
12 generation unit
13 transmission unit
10B information processing device
15 acquisition unit
16 reception unit
17 decryption unit
20 storage server
30 key supply base
31 transmitter
32 receiver
33 key management server

What is claimed is:

1. A communication system comprising a first information processing device, a second information processing device, and a key supply base, wherein
the first information processing device includes:
at least one first memory storing computer-executable instructions; and
at least one first processor configured to access the at least one first memory and execute the computer-executable instructions to:
obtain key data from the key supply base;
encrypt first data using the key data, and generate second data in which attribute information regarding encryption is added to the encrypted first data; and
upload the second data to an external device, and
the second information processing device includes:
at least one second memory storing computer-executable instructions; and
at least one second processor configured to access the at least one second memory and execute the computer-executable instructions to:
obtain the key data from the key supply base;
download the second data from the external device; and
identify the key data based on the attribute information included in the second data, and decrypt the first data included in the second data using the key data.

2. The communication system according to claim 1, wherein the key supply base performs quantum key distribution (QKD) for detecting eavesdropping using a principle of quantum mechanics at a time of distributing the key data.

3. The communication system according to claim 1, wherein the attribute information includes identification information of the key data.

4. The communication system according to claim 1, wherein the attribute information includes identification information of a user of the first information processing device.

5. The communication system according to claim 1, wherein the attribute information includes identification information of a user of the second information processing device.

6. The communication system according to claim 1, wherein the attribute information includes identification information of a group including a user of the first information processing device and a user of the second information processing device.

7. The communication system according to claim 1, wherein the attribute information includes information indicating a time limit by which the first data may be decrypted using the key data.

8. The communication system according to claim 1, wherein the attribute information includes information indicating an encryption scheme used to encrypt the first data.

9. An information processing device comprising:
at least one memory storing computer-executable instructions; and
at least one processor configured to access the at least one memory and execute the computer-executable instructions to:
obtain key data from a key supply base;
encrypt first data using the key data, and generate second data in which attribute information regarding encryption is added to the encrypted first data; and
upload the second data to an external device.

10-11. (canceled)

12. A computer-implemented communication method being performed by at least one processor executing stored instructions to perform steps comprising:
obtaining key data from a key supply base;
encrypting first data using the key data and generating second data in which attribute information regarding encryption is added to the encrypted first data; and
uploading the second data to an external device.

13-15. (canceled)
